(19) United States
(12) Patent Application Publication
(10) Pub. No.: US 2011/0157368 A1
(43) Pub. Date: Jun. 30, 2011

(54) METHOD OF PERFORMING HANDOFF BETWEEN PHOTOGRAPHING APPARATUSES AND SURVEILLANCE APPARATUS USING THE SAME

(75) Inventor: Young-gwan JO, Changwon-city (KR)

(73) Assignee: SAMSUNG TECHWIN CO., LTD., Changwon-city (KR)

(21) Appl. No.: 12/909,166

(22) Filed: Oct. 21, 2010

(30) Foreign Application Priority Data
Dec. 31, 2009 (KR) 10-2009-0136143

(51) Int. Cl. H04N 7/18

(52) U.S. Cl. 348/159; 348/E07.085

(57) ABSTRACT

Provided are a method of performing a handoff between photographing apparatuses and a surveillance apparatus using the method. The method includes: displaying a first area which is captured by a first photographing apparatus among the plurality of photographing apparatuses; displaying first icons corresponding to peripheral areas, among the plurality of areas, neighboring the first area; and displaying a second area, among the peripheral areas, which is captured by a second photographing apparatus, among the plurality of photographing apparatus, corresponding to an icon selected among the first icons.

### CROSS-REFERENCE TO RELATED PATENT APPLICATION

This application claims priority from Korean Patent Application No. 10-2009-0136143, filed on Dec. 31, 2009, the disclosure of which is incorporated herein in its entirety by reference.

### BACKGROUND

1. Field

Apparatuses and methods consistent with exemplary embodiments relate to a surveillance system, and more particularly, to a surveillance system for photographing surveillance areas using a plurality of cameras, providing photographing results to a user, and recording the photographing results.

2. Description of the Related Art

A plurality of cameras are installed in a surveillance system in order to simultaneously survey wide areas or areas separated by artificial structures or natural objects. If a target object moves beyond a visual field of a camera when a surveillance system using multiple cameras tracks the target object, a user is required to convert a main surveillance screen of the camera into a main surveillance screen of another camera having a visual field capable of capturing the target object. A process of selecting a camera having a visual field capable of capturing a moving object or displaying an image of the camera on a main surveillance screen in order to continuously track the moving object in a surveillance system using multiple cameras is referred to as a camera handoff or a camera handover.

A related-art surveillance system using multiple cameras divides a monitor screen into a plurality of sectors and respectively displays images of the multiple cameras on the plurality of sectors, or installs several monitors and displays an image transmitted from a camera on each of the several monitors. FIG. 1 illustrates a monitor which is divided into 16 sectors which respectively display images transmitted from different cameras. FIG. 2 illustrates a monitor which displays an image transmitted from a specific camera in the center thereof

If a target object appears on one sector of a divided screen or a monitor when a user is sequentially observing the plurality of sectors of the divided screen, the user focuses on the sector on which the target object appears.

If the user selects the sector displaying the target object (refer to FIG. 1), the selected sector is enlarged in the center of a screen of the monitor or occupies a whole part of the screen of the monitor (refer to FIG. 2).

If the target object moves out of the selected sector after a predetermined period of time, the user will select another sector of a camera on which the target object re-appears (corresponding to a case where visual fields of two cameras overlap with each other) or will re-appear (corresponding to a case where the visual fields of the two cameras do not overlap with each other). Operations of tracking the target object, the target object's moving out of sectors of a divided screen, and performing handoffs among the cameras are repeated until the target object completely moves out of the visual fields of all cameras of the surveillance system using the multiple cameras.

If a current target object moves beyond a visual field of a camera including the current target object, a user performs a camera handoff with respect to a camera on which the current target object re-appears. When the user performs the camera handoff, the user should search through several sectors of a divided screen to detect on which sector the current target object has re-appeared. Here, the user should sufficiently learn about position relations among cameras constituting the surveillance system. This is because the user is able to rapidly and accurately select (i.e., perform a handoff with respect to) a sector of a divided screen on which the current target object has reappeared (or will reappear) only when the user sufficiently learns about the position relations.

However, as the number of cameras constituting the surveillance system increases, cost and labor required for the user to learn increase. Also, if the user has not sufficiently learned about the position relations, the user has to search for a sector of a divided screen on which the target object has reappeared (or will reappear), among all sectors of the divided screen. Time required for performing a handoff increases with the increase in the number of cameras. Accordingly, a possibility of failing to perform a handoff with respect to an object which is rapidly moving increases, which lowers a performance of the surveillance system.

### SUMMARY

One or more of the exemplary embodiments provides a method of performing a handoff between photographing apparatuses by which icons used for inputting display commands for peripheral areas of a currently displayed area are displayed together and an area captured by a designated photographing apparatus is displayed according to a selected icon, and a surveillance apparatus using the same.

According to an aspect of an exemplary embodiment, there is provided a method of performing a handoff between a plurality of photographing apparatuses capturing a plurality of areas, respectively, the method including: displaying a first area which is captured by a first photographing apparatus among the plurality of photographing apparatuses; displaying first icons corresponding to peripheral areas, among the plurality of areas, neighboring the first area; and displaying a second area, among the peripheral areas, which is captured by a second photographing apparatus, among the plurality of photographing apparatus, corresponding to an icon selected among the first icons.

The selected icon may be an icon which is manually selected by a user.

Positions in which the first icons are displayed may be determined based on position relations between the first area and the peripheral areas.

The method may further include displaying second icons corresponding to peripheral areas of the second area.

At least one icon of the first icons may be displayed differently from the other icons of the first icons according to a probability of an object, which appears in the first area and is to be tracked, to move to the peripheral areas.

The first icons may be displayed in different colors according to the probability.

The method may further include checking a motion trajectory of an object which appears in the first area, wherein the icon corresponding to the second area is selected based on the checked motion trajectory. Alternatively, the method may include checking a motion trajectory of an object which appears in the first area, wherein the second area is automatically displayed based on the checked motion trajectory

The method may further include, if it is determined that the object does not exist in the second area, redisplaying the first area.

The peripheral areas may be displayed along with the first icons on the first screen.

The first icons may be displayed at an edge of the first area on the first screen.

According to an aspect of another exemplary embodiment, there is provided a surveillance apparatus connected to a plurality of photographing apparatuses which captures a plurality of areas, respectively, the apparatus including: an image former which generates a first screen which displays a first area captured by a first photographing apparatus among the plurality of photographing apparatuses; and a controller which controls the image former to generate and add to the first screen first icons corresponding to peripheral areas, among the plurality of areas, neighboring the first area, and controls the image former to generate a second screen which displays a second area captured by a second photographing apparatus, among the plurality of photographing apparatuses, corresponding to an icon selected among the first icons.

The selected icon may be an icon which is manually selected by a user.

Positions in which the first icons are displayed may be determined based on position relations between the first area and the peripheral areas.

The controller may control the image former to add second icons corresponding to peripheral areas of the second area, on the second screen.

The controller may control the image former to generate the first icons such that at least one icon of the first icons is displayed differently from the other icons of the first icons according to a probability of an object, which appears in the first area and is to be tracked, to move to the peripheral areas.

The controller may control the image former to generate the first icons in different colors according to the probability.

The controller may check a motion trajectory of an object which appears in the first area, and selects the icon corresponding to the second area based on the motion trajectory. Alternatively, the controller may check a motion trajectory of an object which appears in the first area, and controls the image former to automatically generate the second screen based on the motion trajectory.

If the object does not exist in the second area, the controller may control the image former the image former to generate the first screen again or a third screen which redisplays the first area.

The controller may control the image former such that the peripheral areas are displayed along with the first icons on the first screen.

The controller may control the image former such that the icons are displayed at an edge of the first area on the first screen.

### BRIEF DESCRIPTION OF THE DRAWINGS

The above and other aspects will become more apparent by describing in detail exemplary embodiments with reference to the attached drawings, in which:

FIGS. 1 and 2 illustrate conventional methods of providing an image of a surveillance area captured by a related-art surveillance system;

FIG. 3 is a block diagram of a surveillance system according to an exemplary embodiment;

FIG. 4 is a block diagram of a surveillance apparatus of FIG. 3, according to an exemplary embodiment;

FIG. 5 is a table illustrating position relations among surveillance areas and correspondence relations between the surveillance areas and cameras, according to an exemplary embodiment;

FIG. 6 is a flowchart of a method of performing a manual camera handoff, according to an exemplary embodiment;

FIG. 7 illustrates a monitor displaying a result of performing an operation of the method of FIG. 6, in which an image former is controlled to generate a screen, according to an exemplary embodiment;

FIG. 8 illustrates a monitor displaying results of performing operations of the method of FIG. 6, in which the image former is controlled to enlarge and display a selected surveillance area and to add area conversion icons as graphical user interface (GUI) elements around the enlarged surveillance area, according to an exemplary embodiment; and

FIG. 9 is a flowchart of a method of performing an automatic camera handoff, according to an exemplary embodiment.

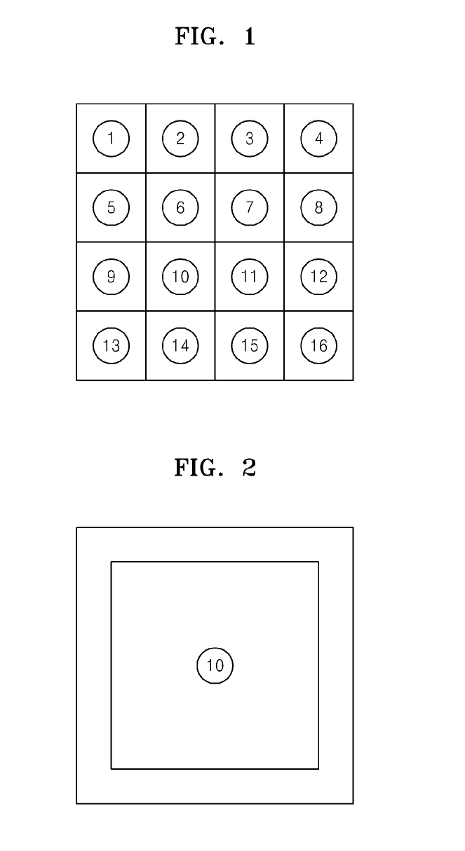

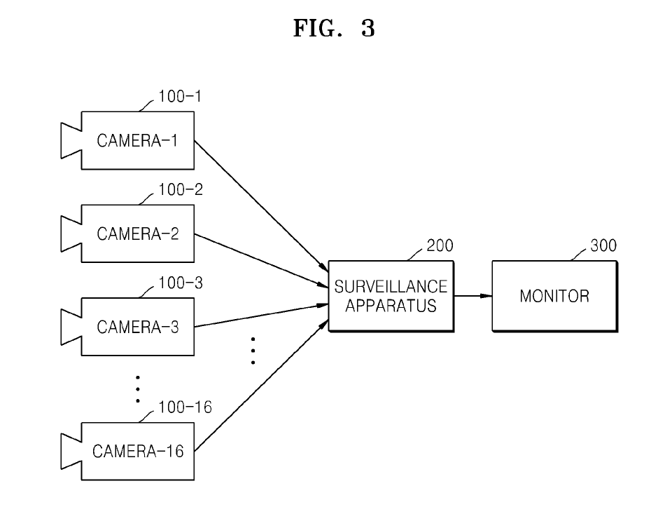

### DETAILED DESCRIPTION OF EXEMPLARY EMBODIMENTS

Exemplary embodiments will now be described in detail with reference to the attached drawings.

FIG. 3 is a block diagram of a surveillance system according to an exemplary embodiment. Referring to FIG. 3, the surveillance system includes a plurality of cameras 100-1 through 100-16, a surveillance apparatus 200, and a monitor 300 which are connected to one another.

The plurality of cameras 100-1 through 100-16 are respectively installed in surveillance areas, generate images by capturing surveillance areas in which the plurality of cameras 100-1 through 100-16 are positioned, and transmit the images to the surveillance apparatus 200. In more detail, the camera-1 100-1 captures a surveillance area-1, the camera-2 100-2 captures a surveillance area-2, . . . , and the camera-16 100-16 captures a surveillance area-16.

The surveillance apparatus 200 receives the images of the surveillance areas captured by the plurality of cameras 100-1 through 100-16, and generates a screen divided into a plurality of sectors respectively displaying the images or a screen displaying only an image of a surveillance area received from a specific camera. The surveillance apparatus 200 transmits the generated screen to the monitor 300.

The monitor 300 displays the screen received from the surveillance apparatus 200 to a user.

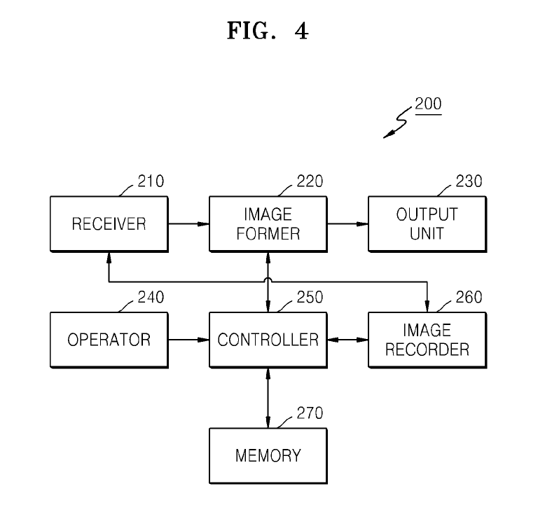

FIG. 4 is a block diagram of the surveillance apparatus 200 of FIG. 3. Referring to FIG. 4, the surveillance apparatus 200 includes a receiver 210, an image former 220, an output unit 230, an operator 240, a controller 250, an image recorder 260, and a memory 270.

The receiver 210 receives the images of the captured surveillance areas from the plurality of cameras 100-1 through 100-16, and transmits the images to the image former 220.

The image former 220 reconstitutes the images received from the receiver 210 to generate a screen which is to be displayed on the monitor 300. In more detail, the image former 220 arranges and reconstitutes all or some of the images received from the receiver 210 on a screen. The image former 220 may also constitute a screen using one image.

The image former 220 may add graphical user interface (GUI) elements to the reconstituted screen. The GUI elements includes information windows for providing specific information to the user, icons used for inputting messages or commands for specific operations, and the like.

The reconstitution of the images and the addition of the GUI elements are performed by the image former 220 under control of the controller 250 which will be described later.

The output unit 230 is connected to the monitor 300, and transmits the screen generated by the image former 220 to the monitor 300. The image recorder 260 records the images of the surveillance areas received through the receiver 210 in a recording medium.

The operator 240 receives an input from the user, and transmits a corresponding signal to the controller 250. The controller 250 controls an operation of the surveillance apparatus 200 according to the signal transmitted from the operator 240.

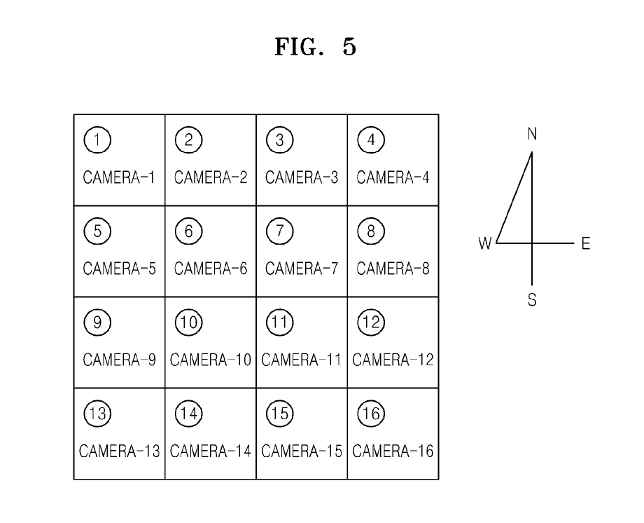

The memory 270 stores programs and information that the controller 250 requires to control the operation of the surveillance apparatus 200. In particular, the memory 270 stores a table which shows position relations among surveillance areas and correspondence relations between the surveillance areas and cameras. This table is exemplarily illustrated in FIG. 5.

According to the table illustrated in FIG. 5, the position relations among the surveillance areas are checked. For example, west “W” of a surveillance area-10 may be the surveillance area-9, northwest “NW” of the surveillance area-10 may be a surveillance area-5, south “S” of the surveillance area-10 may be a surveillance area-14, and east “E” of the surveillance area-10 may be a surveillance area-11.

The controller 250 may automatically or manually perform a camera handoff with reference to the table illustrated in FIG. 5. The automatic and manual handoffs will be now described in detail.

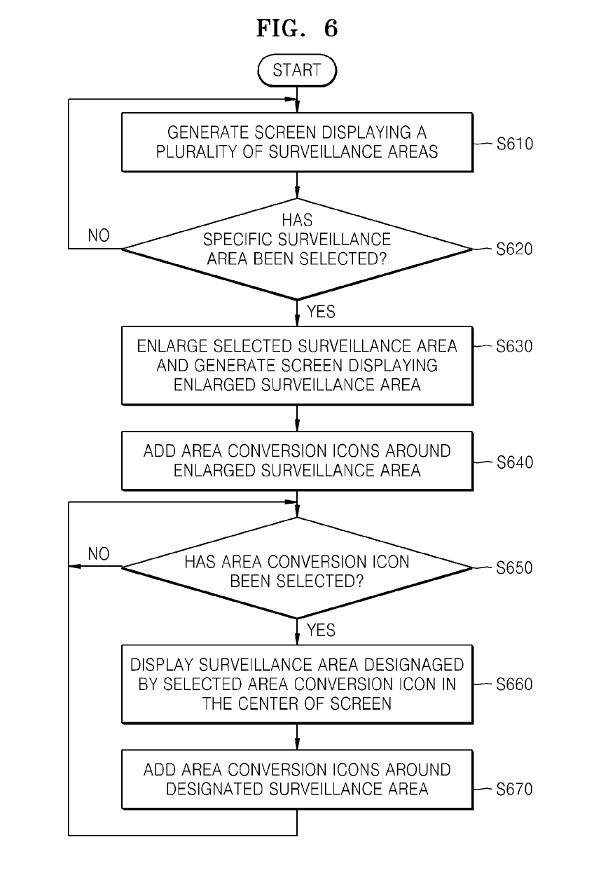

FIG. 6 is a flowchart of a method of performing a manual camera handoff, according to an exemplary embodiment. Referring to FIG. 6, in operation S610, the controller 250 controls the image former 220 to generate a screen including a plurality of surveillance areas captured by the plurality of cameras 100-1 through 100-16.

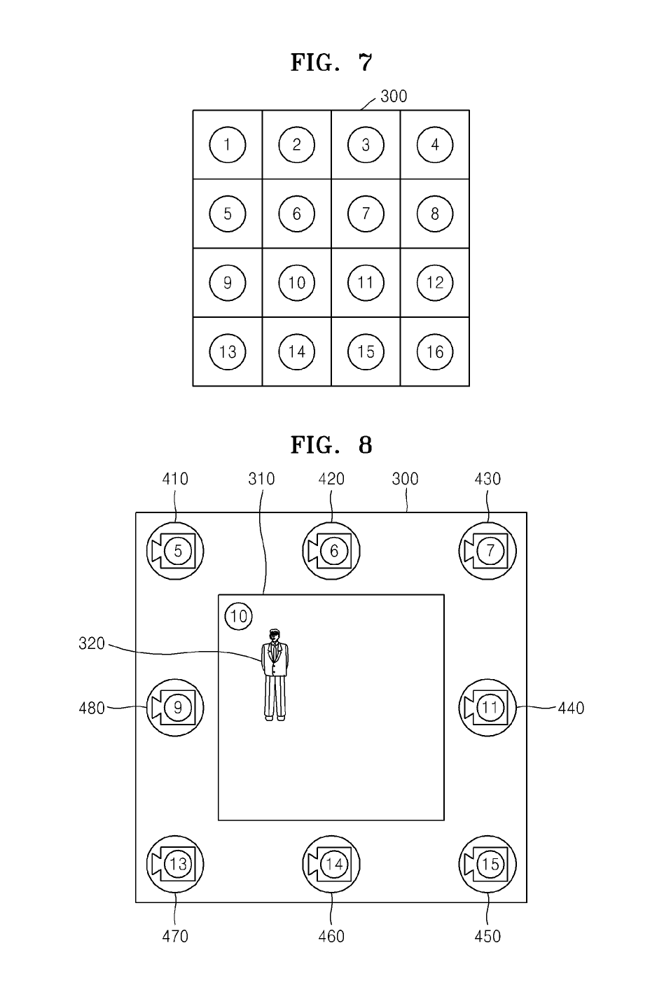

Thus, as shown in FIG. 7, the monitor 300 displays a screen which includes images formed by capturing 16 surveillance areas. A user may select one of the surveillance areas displayed on the monitor 300 through the operator 240. The surveillance area selected by the user is generally an area in which an object to be surveyed appears.

In operation S620, a determination is made as to whether the user has selected a specific surveillance area through the operator 240. If it is determined in operation S620 that the user has selected the specific area, the controller 250 controls the image former 220 to enlarge the selected surveillance area and generate a screen which displays the enlarged selected surveillance area in the center of the screen in operation S630. In operation S640, the controller 250 controls the image former 220 to add area conversion icons as GUI elements around the enlarged surveillance area.

A screen of the monitor 300 displaying the results of performing operations S630 and S640 is illustrated in FIG. 8. As shown in FIG. 8, a surveillance area-10 310 in which an object 320 to be tracked appears is enlarged in the center of the screen displayed on the monitor 300.

Referring to FIG. 8, eight (8) area conversion icons 410 through 480 are added around the surveillance area-10 310. The area conversion icons 410 through 480 refer to icons which are selected to input commands for converting a surveillance area displayed in the center of a current screen to another surveillance area positioned around the surveillance area-10 310.

Positions in which the area conversion icons 410 through 480 are to be added on the screen are determined based on a position relation between peripheral surveillance areas to be displayed when they are selected and the surveillance area-10 310 which is currently displayed in the center of the screen.

For example, an area conversion icon-4 410 used for inputting a conversion command into the surveillance area-5 is displayed northwest “NW” of the surveillance area-10. This is because the surveillance area-5 is positioned northwest “NW” of the surveillance area-10 displayed in the center of the current screen. An area conversion icon-8 480 used for inputting a conversion command into a surveillance area-9 is displayed west “W” of the surveillance area-10. This is because the surveillance area-9 is positioned west “W” of the surveillance area-10 displayed in the center of the current screen.

The user may manually select one of the area conversion icons 410 through 480 displayed on the screen of FIG. 8 through the operator 240. The selection of the area conversion icon is generally performed with reference to a movement of the object 320 which is to be tracked.

In other words, if the object 320 has disappeared or will disappear by moving toward the northwest “NW” of the surveillance area-10 310 displayed in the center of the current screen, the user will select the area conversion icon-1 410. If the object 320 has disappeared or will disappear by moving toward the west “W” of the surveillance area-10 310 displayed in the center of the current screen, the user will select the area conversion icon-8 480.

In operation S650, it is determined whether the user has selected an area conversion icon. If it is determined in operation S650 that the user has selected the area conversion icon, the controller 250 controls the image former 220 to generate a screen which displays a surveillance area designated by the selected area conversion icon, in the center of the screen in operation S660.

If the area conversion icon determined to be selected in operation S650 is the area conversion icon-9 480, the controller 250 controls the image former 220 to generate a screen which displays an image, which is received from the camera-9 100-9 capturing the surveillance area-9 designated by the area conversion icon-8 480, in the center of the screen. The fact that the camera capturing the surveillance area-9 is the camera-9 100-9 may be checked with reference to the table illustrated in FIG. 5.

In operation S670, the controller 250 controls the image former 220 to add area conversion icons around the designated surveillance area-9. As in operation S640, in operation S670, the positions of the area conversion icons are determined based on a position relation between peripheral surveillance areas to be displayed when they are selected and the surveillance area-9 currently displayed in the center of the screen. Operations S650 through S670 are repeated.

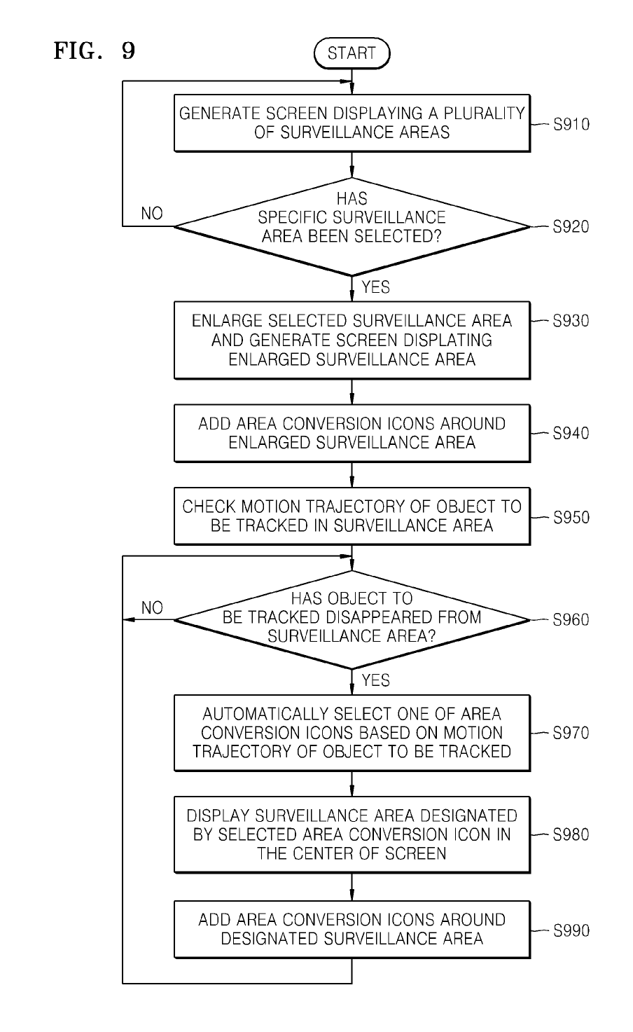

The process of performing the manual cameral handoff has been described in detail. A process of performing an automatic camera handoff will now be described in detail with reference to FIG. 9.

FIG. 9 is a flowchart of a method of performing an automatic camera handoff, according to an exemplary embodiment. Referring to FIG. 9, in operation S910, the controller 250 controls the image former 220 to generate a screen which displays a plurality of surveillance areas captured by the plurality of cameras 100-1 through 100-16.

In operation S920, it is determined whether a user has selected a specific surveillance area through the operator 240. If it is determined in operation S920 that the user has selected the specific surveillance area, the controller 250 controls the image former 220 to enlarge the selected surveillance area and generate a screen which displays the enlarged selected surveillance area in a center of the screen in operation S930. In operation S940, the controller 250 controls the image former 220 to add area conversion icons as GUI elements around the enlarged surveillance area. The results of performing operations S930 and S940 are as displayed on the screen of the monitor 300 illustrated in FIG. 8.

In operation S950, the controller 250 checks a motion trajectory of an object to be tracked in a surveillance area in real time. In operation S960, it is determined whether the object 320 has disappeared from the surveillance area. If it is determined in operation S960 that the object 320 has disappeared from the surveillance area, the controller 250 automatically selects one icon among area conversion icons based on the motion trajectory checked in operation S950, in operation S970.

For example, as shown in FIG. 8, if it is determined that the object 320 has disappeared to the northwest “NW” of the surveillance area-10 310 displayed in the center of the current screen, the controller 250 selects the area conversion icon-1 410. If it is determined that the object 320 has disappeared to the west “W” of the surveillance area-10 310 displayed in the center of the current screen, the controller 250 selects the area conversion icon-8 480.

In operation S980, the controller 250 controls the image former 220 to generate a screen which displays a surveillance area, which is designated by the selected area conversion icon, in the center of the screen. In operation S990, the controller 250 controls the image former 220 to add area conversion icons around the enlarged surveillance area. Operations S950 through S990 are repeated.

If it is determined in operation S980 that the object to be tracked does not exist in the surveillance area displayed in the center of the screen, the controller 250 may control the image former 220 to generate a screen which redisplays a previous surveillance area. Also, the controller 250 may control the image former 220 to generate a screen which redisplays another surveillance area.

The surveillance system and the methods of performing the automatic and manual camera handoffs according to exemplary embodiments have been described in detail.

The exemplary embodiments exemplify the surveillance system which surveys 16 surveillance areas. However, the present inventive concept is not limited thereto, and may adopt a surveillance system which surveys surveillance areas exceeding or less than 16.

As illustrated and described by the exemplary embodiments, area conversion icons are displayed around a surveillance area enlarged in a center of a screen. This is merely an example and is given for convenience of description. Area conversion icons which are displayed at an edge of or in a surveillance area, itself, enlarged in a center of a screen may be applied to the present invention.

In the exemplary embodiments described above, the area conversion icons are equally displayed. However, the area conversion icons may be respectively differently displayed. For example, the area conversion icons may be displayed in different colors based on a probability of an object to be tracked moving from a current surveillance area to peripheral surveillance areas. For example, the icons used for selecting peripheral areas having a high probability of the object moving thereto may be displayed in a red color, and the other icons may be displayed in green colors.

A probability of the object moving from the current surveillance area to the peripheral areas may be calculated based on data with respect to previously performed handoffs. For example, if the number of handoffs performed from a surveillance area-10 to a surveillance area-5 is greater than the number of handoffs performed from the surveillance area-10 to a surveillance area-6, a probability of performing a handoff to the surveillance area-5 may be higher than a probability of performing a handoff to the surveillance area-6.

A probability of the object moving from a surveillance area to other surveillance areas may be input by a user.

The area conversion icons may be displayed together with surveillance areas which are converted through the area conversion icons. For example, an image formed by capturing the surveillance area-5 designated by the area conversion icon-1 410, an image formed by capturing the surveillance area-6 designated by the area conversion icon-2 420, an image formed by capturing the surveillance area-7 designated by the area conversion icon-3 430, . . . , and an image formed by capturing the surveillance area-9 designated by the area conversion icon-8 480 may be downsized and displayed along with the area conversion icons 410 through 480 illustrated in FIG. 8.

As described above, in a method of performing a handoff between photographing apparatuses and a surveillance apparatus using the method according to the exemplary embodiments, icons used for inputting display commands for peripheral areas of a currently displayed area are displayed together. An area captured by a photographing apparatus designated in a selected icon is displayed.

Thus, an intuitive handoff is possible with reference to a surveillance screen. As a result, a user does not need to learn about position relations among photographing apparatuses constituting a surveillance system.

Also, the user may intuitively select a photographing apparatus on which a handoff is to be performed, with reference to the surveillance screen. Thus, the handoff is accurately and rapidly performed, which enables rapid tracking of an object to be surveyed.

The device described herein may comprise a memory for storing program data, a processor for executing the program data, a permanent storage such as a disk drive, a communications port for handling communications with external devices, and user interface devices, including a display, keys, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the inventive concept, a reference has been made to the exemplary embodiments illustrated in the drawings, and specific language has been used to describe these exemplary embodiments. However, no limitation of the scope of the inventive concept is intended by this specific language, and the inventive concept should be construed to encompass all embodiments that would normally occur to one of ordinary skill in the art.

The present inventive concept may be described in terms of functional block components and various processing steps. Such functional blocks may be realized by any number of hardware and/or software components configured to perform the specified functions. For example, the present inventive concept may employ various integrated circuit components, e.g., memory elements, processing elements, logic elements, look-up tables, and the like, which may carry out a variety of functions under the control of one or more microprocessors or other control devices. Similarly, where the elements of the present inventive concept are implemented using software programming or software elements, the present inventive concept may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present inventive concept could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the present inventive concept, and are not intended to otherwise limit the scope of the present inventive concept in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the present inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the present inventive concept, and does not pose a limitation on the scope of the present inventive concept unless otherwise claimed. Numerous modifications and adaptations will be readily apparent to those skilled in this art without departing from the spirit and scope of the present inventive concept.

1. A method of performing a handoff between a plurality of photographing apparatuses capturing a plurality of areas, respectively, the method comprising:
displaying a first area which is captured by a first photographing apparatus among the plurality of photographing apparatuses;
displaying first icons corresponding to peripheral areas, among the plurality of areas, neighboring the first area; and
displaying a second area, among the peripheral areas, which is captured by a second photographing apparatus, among the plurality of photographing apparatus, corresponding to an icon selected among the first icons.

2. The method of claim 1, wherein positions in which the first icons are displayed are determined based on position relations between the first area and the peripheral areas.

3. The method of claim 1, further comprising displaying second icons corresponding to peripheral areas of the second area.

4. The method of claim 1, wherein at least one icon of the first icons are displayed differently from the other icons of the first icons according to a probability of an object, which appears in the first area and is to be tracked, to move to the peripheral areas.

5. The method of claim 4, wherein the first icons are displayed in different colors according to the probability.

6. The method of claim 1, further comprising checking a motion trajectory of an object which appears in the first area, wherein the icon corresponding to the second area is selected based on the checked motion trajectory.

7. The method of claim 6, further comprising, if it is determined that the object does not exist in the second area, redisplaying the first area.

8. The method of claim 1, further comprising checking a motion trajectory of an object which appears in the first area,
wherein the second area is automatically displayed based on the checked motion trajectory.

9. The method of claim 1, wherein the peripheral areas are displayed along with the first icons on the first screen.

10. The method of claim 1, wherein the first icons are displayed at an edge of the first area on the first screen.

11. A surveillance apparatus connected to a plurality of photographing apparatuses which captures a plurality of areas, respectively, the apparatus comprising:
an image former which generates a first screen which displays a first area captured by a first photographing apparatus among the plurality of photographing apparatuses; and
a controller which controls the image former:
to generate and add to the first screen first icons corresponding to peripheral areas, among the plurality of areas, neighboring the first area;
to generate a second screen which displays a second area captured by a second photographing apparatus, among the plurality of photographing apparatuses, corresponding to an icon selected among the first icons.

12. The surveillance apparatus of claim 11, wherein positions in which the first icons are displayed are determined based on position relations between the first area and the peripheral areas.

13. The surveillance apparatus of claim 11, wherein the controller controls the image former to add second icons corresponding to peripheral areas of the second area, on the second screen.

14. The surveillance apparatus of claim 11, wherein the controller controls the image former to generate the first icons such that at least one icon of the first icons is displayed differently from the other icons of the first icons according to a probability of an object, which appears in the first area and is to be tracked, to move to the peripheral areas.

15. The surveillance apparatus of claim 14, wherein the controller controls the image former to generate the first icons in different colors according to the probability.

16. The surveillance apparatus of claim 11, wherein the controller checks a motion trajectory of an object which appears in the first area, and selects the icon corresponding to the second area based on the motion trajectory.

17. The surveillance apparatus of claim 16, wherein the controller determines if the object exists in the second area, and, if the object does not exist in the second area, the controller controls the image former to generate the first screen again or a third screen which redisplays the first area.

18. The surveillance apparatus of claim 11, wherein the controller checks a motion trajectory of an object which appears in the first area, and controls the image former to automatically generate the second screen based on the motion trajectory.

19. The surveillance apparatus of claim 11, wherein the controller controls the image former such that the peripheral areas are displayed along with the first icons on the first screen.

20. The surveillance apparatus of claim 11, wherein the controller controls the image former such that the icons are displayed at an edge of the first area on the first screen.
